(19) United States
(12) Patent Application Publication
(10) Pub. No.: US 2024/0076006 A1
(43) Pub. Date: Mar. 7, 2024

(54) Monocoque shear wall as cooling plate

(71) Applicant: Damon Motors Inc., Vancouver (CA)

(72) Inventors: Derek Dorresteyn, Vancouver (CA); Alexander Chau, Coquitlam (CA)

(21) Appl. No.: 17/939,437

(22) Filed: Sep. 7, 2022

(51) Int. Cl. B62K 11/02; B62J 43/16

(52) U.S. Cl. CPC B62K 11/02; B62J 43/16; B62K 2204/00

(57) ABSTRACT

Presented is a system for cooling components of an electric motor vehicle. It utilizes the cold plate, a large metal plate necessary for cooling the batteries and electronics, as a structural member. Instead of being passively contained, the cold plate is used to increase the torsional rigidity of the monocoque. The structural cold plate takes on shear stresses, unlike a passively-contained, non-structural cold plate. The use of the cold plate itself as a stress member negates the need for additional redundant features or structures in the monocoque to resist forces and prevent flexure. Thus the monocoque can be pared down and its weight minimized or larger component accommodated. Cold plates can be made in several ways, from different materials, of varying thickness and shapes.

### COPYRIGHT MATERIAL

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to a system for cooling a battery pack or an electric circuit. More specifically, it relates to the cold plate and stress members in a motorcycle with a monocoque chassis.

### BACKGROUND

The monocoque of an electric motorcycle is the main battery enclosure that houses or serves as a mount for different components such as a power electronics unit, one or multiple battery packs, and junction boxes. With a lot of potential energy packed into the battery packs, cold plates are strategically designed into the monocoque or elsewhere in the vehicle to control localized heat dissipation, thus maintaining the operating temperature of the whole unit.

A cold plate is usually a thick metal plate designed with a material of high thermal conductivity. Embedded inside the cold plate are passages, which usually have at least one input and output port, so that fluid can move through the metal plate. The heat flows through a thermal interface of the heat-generating component to the cold plate through conduction, and then through convection from the cold plate to the coolant, moving the heat outside the system. That heat is then dissipated through a radiator into ambient air.

The cold plate is also a substantial piece of metal which is added to the vehicle, consequently adding weight. In contemporary electric vehicles, typical battery packs within a monocoque are self-contained boxes and not stressed members of the chassis. Cold plates in an electric vehicle (EV) inverter or battery are typically part of an individual battery pack, module or self-contained unit with enclosures that are similarly not stressed members of the vehicle chassis system.

As a result of the requirements of the electric motorcycle and its necessary components, the contemporary, internal combustion motorcycle model has not reconciled the issues of all of the motorcycle's necessary parts and its limited carrying capacity into the current EV era.

This background is not intended, nor should be construed, to constitute prior art against the present invention.

### SUMMARY OF THE INVENTION

Referring to FIG. 1, there is shown a schematic drawing of what may be a traditional, non-structural cold plate design of the monocoque 10 of an electric motorcycle. Crucial to note is the presence of the traditional cold plate 11 and a structural plate 12. While they are shown here as two parallel metal plates approximately side by side, the location of the cold plate 11 can be anywhere inside the monocoque 10 but the structural plate 12 must form a wall of the monocoque as that is what provides strength to it. The other walls of the monocoque 10 are also structural plates. The volume of these two metal plates combined will be termed Volume A. This is the undesirable, inefficient use of material and weight the invention intends to reduce by combining the cold plate 11 and structural plate 12 in the electric motorcycle. The traditional structural plate 12 is a cast wall of aluminum that is approximately 3.5 mm thick as a minimum and forms an outer side of the monocoque 10. As such, it is a stressed member of the vehicle chassis system.

In the schematic there are three batteries 14, for example, adjacent to the traditional cold plate 11, within the monocoque 10. Lateral to the traditional cold plate 11 is the structural plate 12 of the monocoque 10. The cold plate 11 is a thick metal plate made with a material of high thermal conductivity. Non-structural cold plates 11 are typically made from metallic materials with a high coefficient of heat transfer such as aluminum or copper, without regard to their external stress-bearing capacity.

Embedded inside the cold plate 11 is a coolant channel 16 which usually has at least one input and output port as a coolant passage so that fluid can move through the cold plate. Coolant enters the cooling channel 16 from outside the system through the input port 17. Here, the flow travels through the passage from the bottom of the array to the top. The coolant flows vertically through the cooling channel within the cold plate 11 and then exits via the cooling channel output port 18, out of the other end of the cold plate 11.

The three batteries 14 each have physical contact with the cold plate 11 and transfer their heat to the cold plate at their interfaces with it. The heat flows from the batteries 14 to the cold plate 11 through the thermal interface via conduction. The cold plate 11 then transfers its heat by convection to the fluid in the cooling channel 16 running through it. As the heated coolant moves away from the heat source, it moves the heat outside of the system by way of the cooling channel output port 18. Then, relatively cooler coolant moves into the location from where the heated coolant fluid has been displaced. The heated coolant then passes through a radiator cooled by the ambient air via convection. As the heated air moves away from the radiator, and rises, it removes the heat from the system by way of the airflow. Then, relatively cooler air moves into the location from where the heated air has been displaced, in a cyclic formation. The radiators are in front of and lower than the monocoque, or on the sides, which are typical radiator locations on a motorcycle due to aerodynamic requirements and the airflow.

The present invention is a system for cooling an electric motorcycle's battery pack, power electronics and/or electric motor. The invention has elements that may be seen in the Damon HyperDrive™ motorcycle core, for example, which includes a monocoque. The inventors have realized that the weight of a motorcycle can be reduced by combining the functions of two components into one modified and strategically positioned component. The essence of this invention is to utilize the cold plate as a structural member. Instead of being passively contained, the cold plate is used to increase the torsional rigidity of the monocoque by taking on shear stresses. This is different from the conventional use of the non-structural cold plate.

The use of the cold plate itself as a stress member in the present invention reduces the need for additional features or structures in the monocoque to resist forces and prevent flexure or torsion. The cold plate thus takes on two functions, one as a cold plate and the other as a stress member of the motorcycle, allowing the overall redundant metal presence, space consumption, and parasitic weight to be minimized, as well as saving power with that weight reduction. It is accomplished due to the unique design of the monocoque, not as a typical box but as a modified clamshell enclosure. It is this clamshell enclosure that, due to the shape of its two sides, is open in the front. A structural cold plate closes the opening between the two clamshell sides and is a necessary part to stiffen the joint region. Due to the modified clamshell configuration, the cold plate is used as a shear wall to increase the torsional rigidity of the monocoque itself.

The modified clamshell and structural cold plate help to optimally position the center of mass of the motorcycle in a way that the center of mass would move forward if the cover over the cold plate or another wall in the monocoque were needed to enforce the clamshell instead of the structural cold plate. With the physical features of the monocoque helping to optimally locate the center of mass of the motorcycle in this fashion, the structural cold plate is also an efficient way to reinforce the vehicle structure and minimize its weight. A traditional cold plate is already heavy, so it merits using a modified, structural cold plate to replace the traditional structural plate. The use of a structural cold plate may also lend itself to further weight reductions in certain other areas.

Disclosed is a monocoque for a motorcycle comprising a shear wall that forms an outer wall of the monocoque and a cooling channel running through the shear wall. Also disclosed is a motorcycle comprising a monocoque, the monocoque comprising a shear wall that forms an outer wall of the monocoque and a cooling channel running through the shear wall.

### BRIEF DESCRIPTION OF THE DRAWINGS

The following drawings illustrate embodiments of the invention, which should not be construed as restricting the scope of the invention in any way.

FIG. 1 is a schematic drawing of a non-structural cold plate in a monocoque.

FIG. 2 is a schematic drawing of a structural cold plate, according to an embodiment of the present invention.

FIG. 3 is a schematic, partially exploded, perspective view of a modified clamshell structure of a monocoque, according to an embodiment of the present invention.

FIG. 4 is a perspective view of a motorcycle monocoque, according to an embodiment of the present invention.

FIG. 5 is a perspective view of a motorcycle monocoque from the side, according to an embodiment of the present invention.

FIG. 6 is a schematic sectional view showing a cover and structural cold plate sharing the same bolt connections, according to an embodiment of the present invention.

FIG. 7 is a schematic sectional view showing a cover and structural cold plate using independent bolt connections, according to an embodiment of the present invention.

FIG. 8 is a schematic drawing of a cold plate and its channel, according to an embodiment of the present invention.

FIG. 9 is a schematic drawing of another cold plate and its channel, according to an embodiment of the present invention.

FIG. 10 is a schematic drawing of the top of one layer of a cold plate, according to an embodiment of the present invention.

FIG. 11 is a schematic drawing of the bottom of the top layer of the cold plate of FIG. 10, according to an embodiment of the present invention.

### DETAILED DESCRIPTION

### A. Glossary

CFD—Computational Fluid Dynamics. CFD software creates simulations that engineers and analysts use to intelligently predict how liquids and gases will perform under flow.

Chassis—the base frame of a car, carriage, or other wheeled vehicle. The chassis may be a monocoque instead of a frame.

Conduction—the process by which heat or electricity is directly transmitted through a substance when there is a difference of temperature or of potential, respectively, between adjoining regions, without movement of the material.

Convection—the movement caused within a fluid (liquid or gas) by the tendency of hotter and therefore less dense material to rise, and colder, denser material to sink under the influence of gravity, which consequently results in transfer of heat. In free convection, air or liquid moves away from the heated body as the warm air or liquid rises and is replaced by a cooler parcel of air or liquid. In forced convection the fluid motion is generated by an external source (such as a pump, fan, suction device, etc.).

Shear stress—force applied coplanar with a material's cross-sectional plane and, if elevated, tending to cause deformation of a material by slippage along the plane.

Torsional stress—this is caused by a twisting force on an object, which results in shear stress that acts on a transverse cross-section of the object.

### B. Exemplary Embodiments

Referring to FIG. 2, there is shown a structural cold plate 20 of a monocoque 21 of a motorcycle. In the schematic there are three batteries 22, for example, adjacent to the structural cold plate 20, within the monocoque 21 which surrounds the batteries and potentially other components. The structural cold plate 20 is a wall of the monocoque 21.

The structural cold plate 20 is a thick metal plate designed with a material of high thermal conductivity. Although non-structural cold plates are typically made from metallic materials prioritizing the property of having a high coefficient of heat transfer, structural cold plates value better strength-to-weight and stiffness-to-weight ratios. Aluminum and aluminum alloys rank high in strength and stiffness compared to mass. The structural cold plate material needs to have optimal strength, stiffness, and fatigue life for its physical dimensions. Typically, better materials are lighter and less expensive.

The structural cold plate 20 behaves like the traditional non-structural cold plate for cooling purposes. Embedded inside the structural cold plate 20 is a passage 23 which usually has at least one input port 24 and one output port 25 so that the cooling fluid can move through the structural cold plate. Coolant enters the cooling channel 23 from outside the system through the input port 24. Here, the flow travels through the passage from the bottom of the array to the top. The coolant flows vertically through the cooling channel within the structural cold plate 20 and then exits via the cooling channel output port 25, out of the other end of the structural cold plate 20.

The three batteries 22 each have thermal contact with the structural cold plate 20 and transfer their heat to the structural cold plate at their interface with it. The heat flows from the heat-generating component (e.g. battery 22) to the cold plate 20 through the thermal interface between them via conduction.

The structural cold plate 20 then transfers its heat by convection to the cooling channel 23 running through it. As the heated coolant moves away from the heat source, it moves the heat outside the system by way of the cooling channel output port 25. Then, relatively cooler coolant moves into the location from where the heated coolant fluid has been displaced.

The heated coolant then passes through a radiator and is cooled by the ambient air via convection. As the heated air moves away from the heat source, and rises, it removes the heat from the system by way of the airflow. Then, relatively cooler air moves into the location from where the heated air has been displaced, in a cyclic formation. The radiators are in front of and lower than the monocoque, or on the sides, which are typical radiator locations on a motorcycle due to aerodynamic requirements and the airflow.

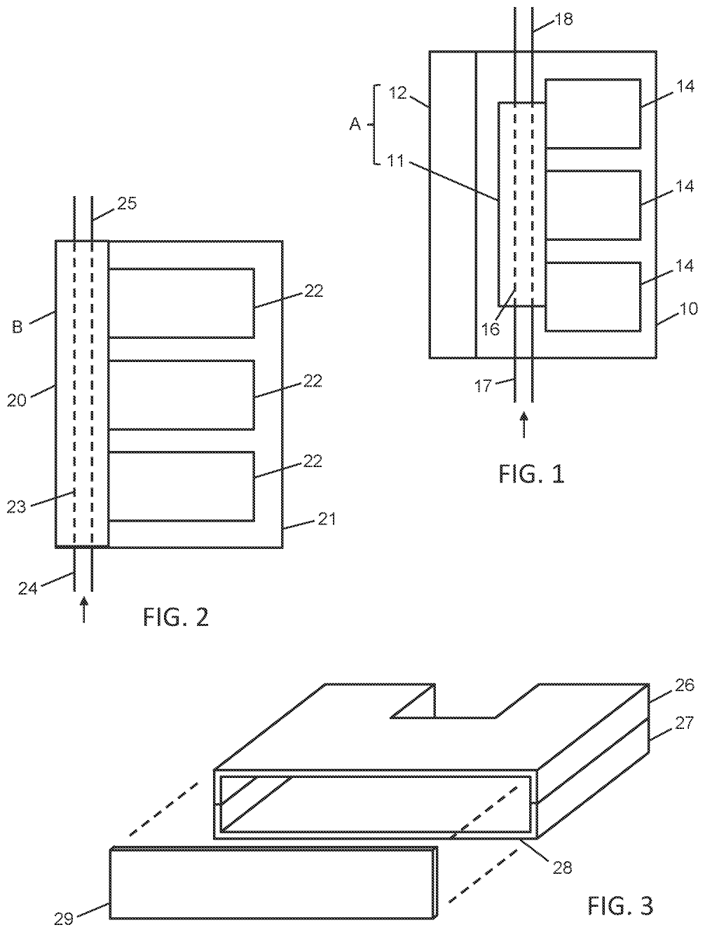

Compared to the combined Volume A (FIG. 1) of the traditional non-structural cold plate assembly, the structural cold plate assembly considers only the structural cold plate 20 as its volume, labeled Volume B. Volume B is less than Volume A, which allows the batteries 22 to be larger than the batteries 14. In the schematic, the relatively thicker size of the structural cold plate 20 compared to the structural plate 12 can be seen as it needs to provide the necessary structural support to the monocoque 21 as a stressed member of the vehicle chassis, while also embodying cooling channels. The structural cold plate 20 spans the same length and width as did the structural plate 12 (FIG. 1) that it replaces. While the traditional structural plate 12 is a cast wall of aluminum that is approximately 3.5 mm thick at its minimum, the structural cold plate 20 replaces it with a nominal increase in the thickness of the cold plate by 0.5 mm, for example. The structural cold plate 20 as one wall of the monocoque needs, for example, a 0.5 mm increase in thickness compared to a traditional structural plate to resist the internal pressure, shock and vibration loading that it may experience. The resulting mass reduction, by replacing a structural plate and non-structural cold plate combination with a singular structural cold plate 20, is, in some embodiments, approximately 4.6 kg.

The structural cold plate 20 may have, with all other things being equal, comparable or slightly less cooling effectiveness than the traditional cold plate 11. The traditional cold plate 11 may be closer to its cooling target, and so the structural cold plate 20 may need to be larger and/or have a higher cooling power. However, the impact of the loss of cooling power is negligible, especially in consideration of the overall weight savings gained by eliminating some of the redundant metal weight overall in the electric motorcycle.

Rather than uniformly increasing its thickness, providing the same rigidity as the traditional structural plate 12 can alternately be accomplished by detailing the structural cold plate 20 with ribs and features which tune its stiffness and specifically put structure where it is required. Sculpting the structural cold plate 20 in this manner creates a rigid structure which is lighter than a solid of the same envelope, potentially affording even further weight reduction. The potential for weight reduction is not exhaustible. As the monocoque 21 and its contents are made lighter, even more material can be removed, and the envelope for accommodating components is further opened in certain areas. In addition to selectively varying the thickness of the cold plate 20, its shape can be non-planar in some embodiments.

In utilizing a cold plate as a stressed member the number of connecting points and their placement is important. This is to ensure that there is sufficient transmittal of stress to the plate as well as sufficient cooling.

Referring to FIG. 3, a modified clamshell structure of a monocoque is shown schematically. The clamshell is formed of two shells 26, 27, which, when joined, form a housing with an open face 28. The open face 28 is closed by the addition of a plate 29, which, in embodiments herein, is a structural cold plate. The structural cold plate provides additional torsional rigidity to the monocoque when assembled.

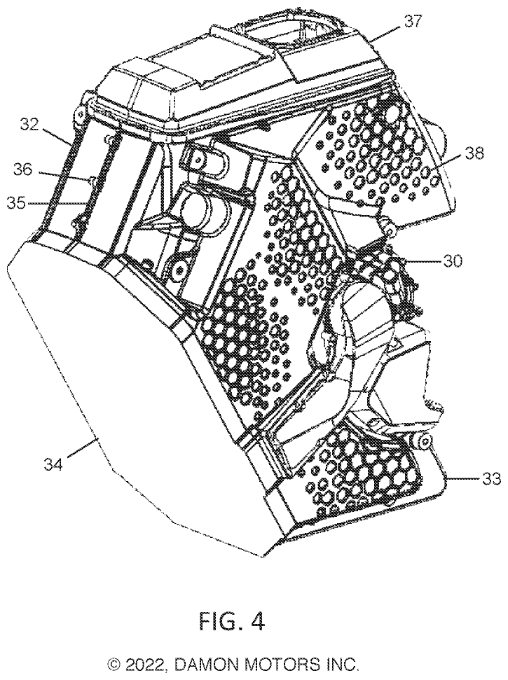

Referring to FIG. 4, there is shown a monocoque 30 that has two shells 32, 33. The cold plate 34 can be seen on the outside of the assembly as part of the monocoque 30. The shells 32, 33 of the monocoque 30 appear approximately symmetrical about the vertical center plane, as shown by a portion of outer bisecting seam 35 above the top of the structural cold plate 34. On that seam can be seen three fasteners 36, a small selection of the many fasteners on the seam around the edges of the shells 32, 33 of the clamshell. A cover 37 may be mounted on the outside of the monocoque 30. Along both outer, lateral surfaces of the shells 32, 33, perpendicular to the structural cold plate 34, are several beehive-like formations 38 with multitudes of recesses. These are side-by-side recesses which are packed together to form the monocoque surface. As opposed to a smooth or flat cover, this beehive-like formation of recesses, while also decorative, contribute strength and have the ability to cool more quickly than a flat surface, while limiting weight. There is additional detailing of some other components or features on the outside of the shells 32, 33.

The structural cold plate 34 occupies a substantial and significant section of the surface area of the monocoque 30, which houses the multiple battery packs, junction boxes, and other electronic components. A power electronics unit may be mounted on the outer surface of the structural cold plate 34. The structural cold plate 34 is a flat plate that closes the opening of the clamshell and in this embodiment it resembles an elongated octagon. Its position as a planar surface mounted to the clamshell sides, how it is mounted, and the construction details of the structural cold plate 34 all affect the stiffness of the monocoque 30, which in turn forms part of the chassis system. Torsional rigidity of the chassis is provided as the structural cold plate 34 is acting as a shear wall. Since the shells 32, 33 form a clamshell enclosure which is open in the front, the structural cold plate 34 is an integral part of the monocoque 30 and provides vehicular chassis strength.

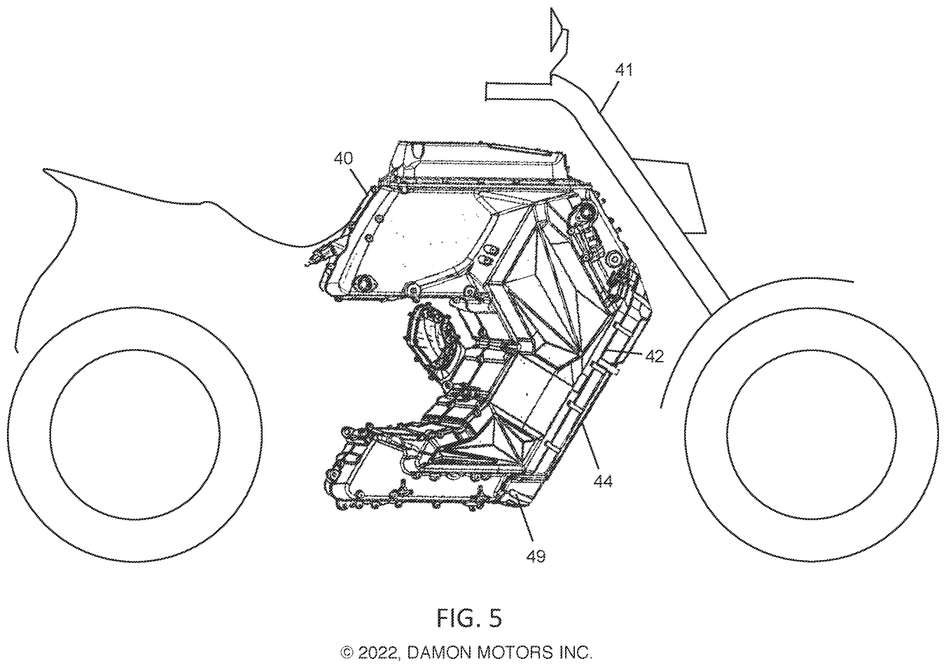

Referring to FIG. 5, there is shown a monocoque 40 as seen from a different angle, the side view of the motorcycle 41. In this view, the perspective is from the opposite side of that of FIG. 4. The structural cold plate 42 is shown here with a cover 44, which may be bolted, clipped or otherwise fixed onto or over the structural cold plate. The cover 44 and structural cold plate 42 may share the same bolt holes for their fixation to the monocoque 40. The monocoque 40 has some detailing on its surface to depict various protruding shapes, which may be used to house fasteners and attach specific items either on its surface or inside the monocoque.

In this illustration the structural cold plate 42 is in the front of the monocoque 40, when the monocoque is in position in the motorcycle 41. The structural cold plate 42 is seen from the side and reveals its length. The structural cold plate 42 is underneath or inside the cover 44, which also houses the power electronics unit. Multiple battery packs and junction boxes are inside the monocoque 40. The power electronics mount to the outer, forward surface of the structural cold plate 42 and the cold plate cover 44 is applied over both the structural cold plate and its surface electronics. This allows for a lightweight, non-structural cover 44, where significant forces do not act on the gasket sealing joint of the cover. The non-structural cover 44 placed around the structural cold plate 42 shields the rider from the structural cold plate and the electronic components attached to the structural cold plate. The cold plate cover 44 has several flange features 49 on each side which extend from the top surface of the cover and reach the side of the cold plate 42. The edge of the cold plate may also be covered.

From the angle in this diagram the cold plate assembly is shown to span almost the entire length of the spine of a block with a “C” shape. The structural cold plate 42 also can be seen to span the side-to-side width of that same spine, as in FIG. 4. Its position as a planar surface mounted to close the clamshell, how it is mounted, and the construction details of the structural cold plate all affect the stiffness of the monocoque 40, which in turn forms part of the chassis system. Torsional rigidity of the chassis is provided as the structural cold plate 42 is acting as a shear wall.

The construction of the monocoque 40 can be further optimized to reduce weight when the structural cold plate 42 acts as a stress member. The lighter, overall weight of the monocoque and its enclosed components means that the forces to which it is subjected are reduced, and as a result the specified strength of the monocoque may be reduced, which in turn may reduce the amount of material used elsewhere in the monocoque. Optimally, the motorcycle mass should be centered between both wheels. With the monocoque 40 now utilizing a structural cold plate 42 as a stress member, and the motorcycle chassis in turn being provided by the monocoque, the center of mass of the motorcycle can more easily be centralized between the two wheels. The use of a structural cold plate 42 also opens up the envelope to allow for more components within the monocoque, or to reduce the overall size of the monocoque, the latter permitting further weight reduction evolutions.

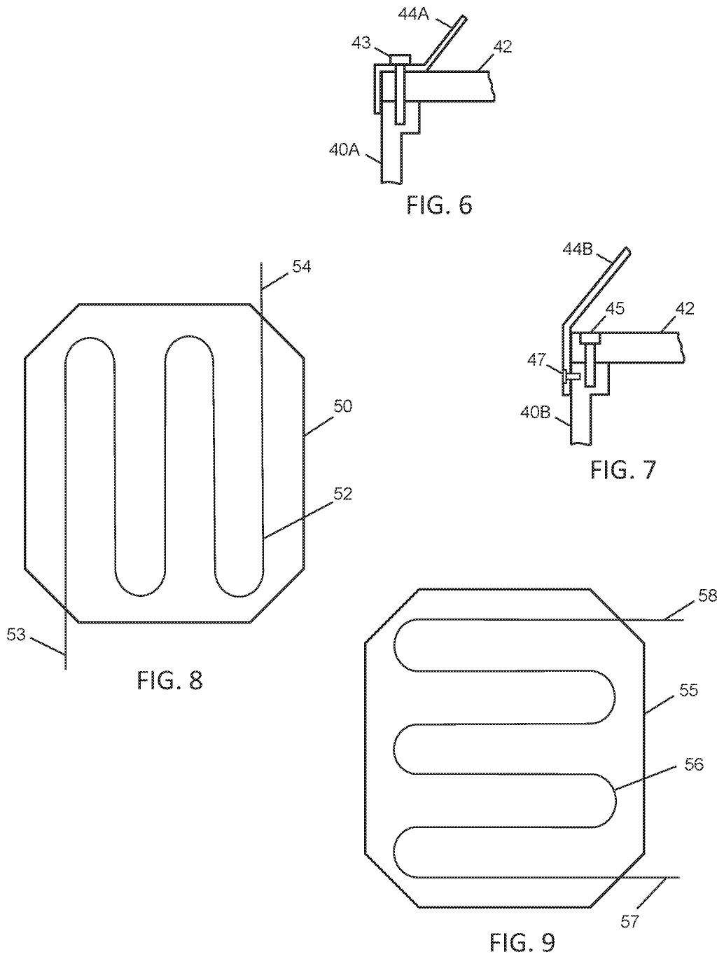

FIG. 6 shows a non-structural cover 44A and structural cold plate 42 sharing the same bolt connections 43 to the monocoque 40A. For example, there may be a plurality of bolts each of which fastens both the cover 44A and structural cold plate 42 to the monocoque 40A.

FIG. 7 shows a non-structural cover 44B and structural cold plate 42 using independent bolt connections 45, 47 respectively to fasten them to the monocoque 40B.

Referring to FIG. 8, there is shown is a stylized view of an example cold plate 50 with cooling channel 52. The present view has a cooling channel 52 in a vertical pattern. In one continuous channel of coolant, the channel begins beyond the cold plate 50, enters through the input port 53, and traverses most of the vertical length of the cold plate. It turns 180 degrees, then again runs most of the vertical length of the cold plate 50 but in the opposite direction, parallel to the first track and slightly displaced laterally in the horizontal direction across the cold plate. The channel turns 180 degrees once more while also again being laterally displaced horizontally in the same horizontal direction as before. The pattern continues in its sinusoidal movement until the channel's vertical passes have been incrementally displaced across the majority of the horizontal width of the cold plate 50. Then, the cooling channel 52 exits the cold plate 50 via the output port 54 and continues beyond it.

According to the schematic, the input and output ports could be switched, depending on the configuration of the embodiment. Coolant could either enter the cooling channel 52 of the vertically aligned pattern at the bottom of the cold plate 50 and exit at the top after traversing the entire array of parallel vertical tracks. Coolant could enter the cooling channel 52 of the vertically aligned pattern from the top of the cold plate 50 and exit at the bottom after traversing the entire array of parallel vertical tracks, depending on the cold plate configuration in the actual embodiment.

FIG. 8 is merely a schematic to show that the vertically aligned passages eventually cover substantially the entire cold plate 50 in a thorough and meticulous sequence. The cooling channel 52 is optimized in CFD software to have consistent flow, no dead regions, and minimal pressure drop.

Referring to FIG. 9, there is shown another stylized view of cold plate 55 with cooling channel 56. The present view has a cooling channel 56 in a horizontal pattern. In one continuous channel of coolant, the channel begins beyond the cold plate 55, enters through the input port 57, and traverses most of the horizontal length of the cold plate. It turns 180 degrees, then again runs most of the horizontal length of the cold plate 55 but in the opposite direction, parallel to the first track and slightly displaced laterally in the vertical direction across the cold plate. The channel turns 180 degrees once more while also again being laterally displaced vertically in the same vertical direction as before. The pattern continues in its sinusoidal movement until the channel's horizontal passes have been incrementally displaced across substantially the entire vertical length of the cold plate 55. The cooling channel 56 then exits the cold plate 55 via the output port 58 from the same side it entered, and continues beyond it.

According to the schematic, the input and output ports could be switched, depending on the configuration of the rest of the monocoque. Coolant could enter the cooling channel 56 of the horizontally aligned pattern near the bottom of the cold plate 55 and exit near the top after traversing the entire array of parallel horizontal tracks. In another embodiment, coolant could enter the cooling channel 56 of the horizontally aligned pattern near the top of the cold plate 55 and exit near the bottom after traversing the entire array of parallel horizontal tracks, depending on the cold plate configuration in the actual embodiment.

FIG. 9 is merely a schematic to show that the horizontally aligned passages eventually cover substantially the entire cold plate 55 in a thorough and meticulous sequence. The cooling channel 56 is optimized in CFD software to have consistent flow, no dead regions, and minimal pressure drop.

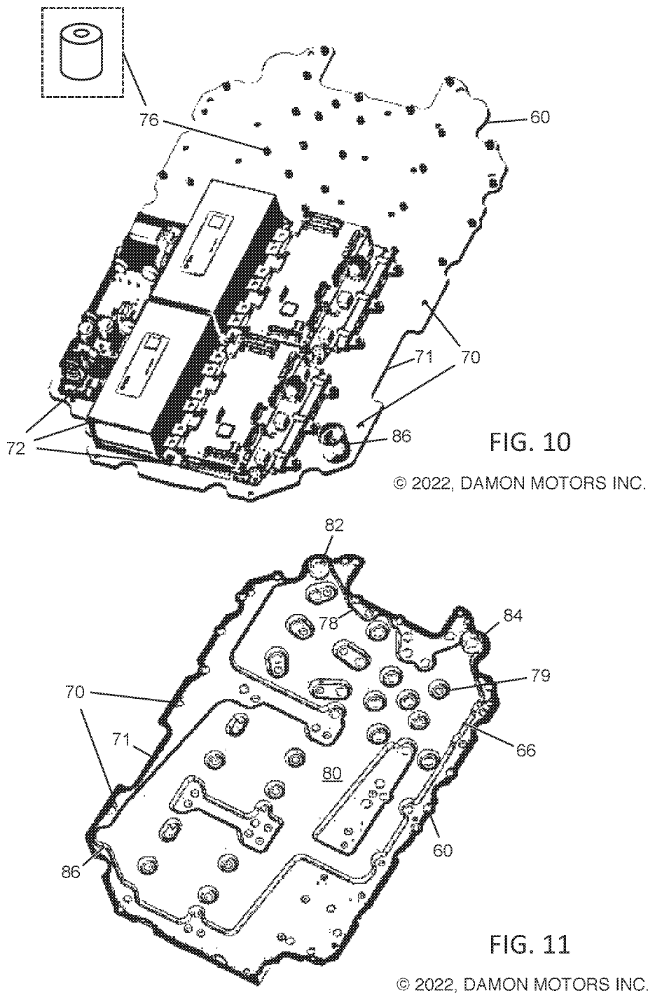

Referring to FIGS. 10 and 11, there is shown the top layer 60 of a structural cold plate. A cold plate is usually in two layers, and FIGS. 10 and 11 only show one of them. The other, bottom layer is a generally plane plate, not shown. Cold plates are made several ways, but here is used a structure with an aluminum plate heat bonded to a metal injection molded part. Two halves bolted or soldered together are common as is casting a copper pipe in a plate of aluminum. All techniques provide a housing or slab with internal coolant passages. The structural cold plate shown here has an elongated octagonal shape with various semi-circular and rounded rectangular cut-outs along its uneven edges. FIG. 11 is the inner side of the top layer 60 of the structural cold plate showing the cooling channels 66. FIG. 10 is flipped sideways (rotated 180 degrees on its long axis) to depict FIG. 11, as can be noted by the position of the securing holes 70 on opposite sides, for example, or the edge cut-out 71.

The location of the cooling channels 66 through the structural cold plate is paramount, targeted to flow where needed so as to efficiently cool while minimizing the coolant volume and flow rate. Electronics 72 require active cooling, and as a result are attached directly to the top layer 60 of the structural cold plate and have cooling channels 66 running directly beneath them on the other side (the internal side) of the top layer of the structural cold plate. The heat-producing electronic components 72 are attached to the top of the structural cold plate with a thermally conductive grease, epoxy, or adhesive. The metal, top layer 60 of the structural cold plate makes physical contact with the attached electronics 72 to transfer their heat to the structural cold plate at their interface and cool them by conduction via that thermal interface. The structural cold plate then transfers its heat by convection to the cooling channels 66 running through it so it can remain a continuous cooling source to the electronics 72 during operation.

Additionally, on the top surface of the cold plate top layer 60 there are short, thick, cylindrical mounting posts or mounting bosses 76. In this depiction there is an enlarged sample to represent around 25 mounting bosses semi-evenly dotted over the upper third of the outer surface of the top layer 60 of the structural cold plate. Each mounting boss 76 corresponds to an aligned channel border 78 or protrusion 79 on the back of layer 60 of the structural cold plate. Coolant floods the cavity between the inner side of top layer 60 shown in FIG. 9 and the inner side of a backing plate that forms the other, bottom side of the structural cold plate. The coolant meanders around the protrusions 79 in the channel 66 so that the protrusions and the base 80 of the channel 66 can then be cooled by convection within the coolant. The fluid flowing through these cooling channels 66 on the top layer 60 of the structural cold plate eventually disseminates the heat through the radiator also via convection.

There are around 9 securing holes 70 around the edge of the top layer 60 of the structural cold plate to secure it to other fixtures in the case, to secure it to the bottom layer of the structural cold plate, or to secure the cold plate cover 44 (FIG. 5) to it.

Referring to FIG. 11, this view shows the cooling channels 66 as sculpted hollows in the inner surface of the top layer 60 of the structural cold plate. The coolant enters from outside the system via the input ports 82, 84, runs through the cooling channel 66 between the top and bottom plates, around and contacting protrusions 79, and exits through the output port 86. The input and output locations may be switched according to the needs of the assembly. The cooling channels 66 are positioned on the inner side of the top plate 60, opposite to the electronics 72, which are attached to the outer side of the top plate by a thermally conductive grease, epoxy, or adhesive. The outer surface of the top layer 60 of the structural cold plate makes physical contact with the attached electronics 72 to transfer their heat to the inner surface 80 of the top layer of the structural cold plate and to the protrusions 79, and thereby to cool the electronics by conduction via that thermal interface. The structural cold plate then transfers its heat by convection to the coolant in the cooling channels 66 running through it.

### C. Variations

Structural cold plates can be made in several ways, including formed metal or injection molded. They can be made from different materials not limited to aluminum and copper. Their components can be bonded, bolted, or soldered together.

The thickness of the structural cold plate can be selectively varied at different points of the plate. Highly specific target areas can be reinforced with details such as ribs and other features that tune the cold plate's stiffness and put structure where it is required, or that provide increased surface area with the coolant. The result of selective detailing is a plate which is just as strong as but lighter than a solid of the same envelope. The shape of the structural cold plate can also be non-planar in some embodiments.

Embodiments, depending on their configuration, may exhibit all or fewer than all of the advantages described herein. Other advantages not mentioned may be present in one or more of the embodiments.

Throughout the description, specific details have been set forth in order to provide a more thorough understanding of the invention. However, the invention may be practiced without these particulars. In other instances, well known elements have not been shown or described in detail and repetitions of features have been omitted to avoid unnecessarily obscuring the invention. Accordingly, the specification and drawings are to be regarded in an illustrative, rather than a restrictive, sense.

It will be clear to one having skill in the art that further variations to the specific details disclosed herein can be made, resulting in other embodiments that are within the scope of the invention disclosed. All parameters, dimensions, materials, quantities, shapes, orientations and configurations described herein are examples only and may be changed depending on the specific embodiment. For example, other monocoque shapes and assembly techniques may be used, provided that at least one wall of the monocoque is a structural cold plate that acts as a shear wall. Accordingly, the scope of the invention is to be construed in accordance with the substance defined by the following claims.

1. A monocoque for a motorcycle comprising:
a shear wall that forms an outer wall of the monocoque; and
a cooling channel running through the shear wall.

2. The monocoque of claim 1 comprising an electric component thermally connected to the shear wall inside the monocoque.

3. The monocoque of claim 2 wherein the electric component is a battery.

4. The monocoque of claim 2 wherein the electric component is an electronic circuit.

5. The monocoque of claim 1 comprising:
an electric component thermally connected to the shear wall outside the monocoque; and
a cover over the electric component.

6. The monocoque of claim 1 wherein the shear wall is a front wall of the monocoque.

7. The monocoque of claim 1 wherein the shear wall is a bottom front wall of the monocoque.

8. The monocoque of claim 1 wherein the shear wall is planar or non-planar or is of non-uniform thickness.

9. The monocoque of claim 1 comprising a cover over the shear wall.

10. The monocoque of claim 1, wherein the cooling channel is uniformly distributed or non-uniformly distributed within the shear plate.

11. The monocoque of claim 1, comprising a first shell and a second shell, wherein the shear wall closes an open face formed by the first and second shells when the first and second shells are connected to each other.

12. A motorcycle comprising a monocoque, the monocoque comprising:
a shear wall that forms an outer wall of the monocoque; and
a cooling channel running through the shear wall.

13. The motorcycle of claim 12 comprising an electric component thermally connected to the shear wall inside the monocoque.

14. The motorcycle of claim 13 wherein the electric component is a battery or an electronic circuit.

15. The motorcycle of claim 12 comprising:
an electric component thermally connected to the shear wall outside the monocoque; and
a cover over the electric component.

16. The motorcycle of claim 12 wherein the shear wall is a front wall of the monocoque or a bottom front wall of the monocoque.

17. The motorcycle of claim 12 wherein the shear wall is planar or non-planar or is of non-uniform thickness.

18. The motorcycle of claim 12, wherein the cooling channel is uniformly distributed or non-uniformly distributed within the shear plate.

19. The motorcycle of claim 12, comprising a first shell and a second shell, wherein the shear wall closes an open face formed by the first and second shells when the first and second shells are connected to each other.

20. The motorcycle of claim 12 comprising a cover over the shear wall.

21. The motorcycle of claim 20, comprising a plurality of bolts each of which fastens both the cover and shear wall to the monocoque.

22. The motorcycle of claim 20, wherein the cover and shear wall are independently fastened to the monocoque.
